(19) United States
(12) Patent Application Publication
(10) Pub. No.: US 2012/0270734 A1
(43) Pub. Date: Oct. 25, 2012

(54) COMPOSITION AND METHOD FOR CONTROLLING PLANT DISEASES

(76) Inventor: Makoto Kurahashi, Nishinomiya-shi, (JP)

(21) Appl. No.: 13/518,095

(22) PCT Filed: Dec. 22, 2010
(86) PCT No.: PCT/JP2010/073850

§ 371 Date: Jul. 11, 2012

(30) Foreign Application Priority Data
Dec. 25, 2009 (JP) 2009-295019

(51) Int. Cl. A01N 43/78; A01P 3/00; A01C 1/06

(52) U.S. Cl. 504/100; 514/370

(57) ABSTRACT

The present invention provides: a composition for controlling plant diseases comprising, as active ingredients, ethaboxam and sedaxane; a method for controlling plant diseases which comprises applying effective amounts of ethaboxam and sedaxane to a plant or soil for growing plant; and so on.

### TECHNICAL FIELD

The present invention relates to a composition for controlling plant diseases and a method for controlling plant diseases.

### BACKGROUND ART

Known as active ingredients of plant diseases controlling agents have been ethaboxam (see, for example, US Patent Publication No. 5514643) and sedaxane (see, for example, National Publication of International Patent Application No. 03/074491). Nevertheless, there is a continuing need for more highly active agents for controlling plant diseases.

### DISCLOSURE OF INVENTION

An object of the present invention is to provide a composition for controlling plant diseases and a method for controlling plant diseases, having excellent control efficacy for plant diseases.

The present invention provides a composition for controlling plant diseases and a method for controlling plant diseases, which exert excellent control efficacy for plant diseases by the combined use of ethaboxam and sedaxane.

Specifically, the present invention provides:

[1] A composition for controlling plant diseases comprising, as active ingredients, ethaboxam and sedaxane;

[2] The composition according to [1], wherein a weight ratio of ethaboxam to sedaxane is in the range of 1:0.01 to 1:50;

[3] A seed treatment agent comprising, as active ingredients, ethaboxam and sedaxane;

[4] A plant seed treated with effective amounts of ethaboxam and sedaxane;

[5] A method for controlling plant diseases which comprises applying effective amounts of ethaboxam and sedaxane to a plant or soil for growing plant; and

[6] Combined use for controlling plant diseases of ethaboxam and sedaxane; and so on.

The composition of the present invention exerts an excellent control efficacy for plant diseases.

### MODES FOR CARRYING OUT THE INVENTION

Ethaboxam for use in the composition for controlling plant diseases of the present invention is a compound disclosed in US Patent Publication No. 5514643. The compound can be obtained from commercial agents or can be obtained by producing by the method described in the publication.

Sedaxane for use in the composition for controlling plant diseases of the present invention is a known compound represented by the formula (1):

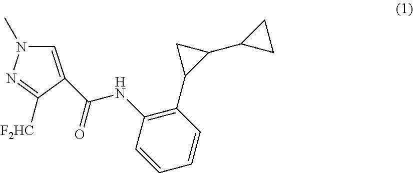

and disclosed in National Publication of International Patent Application No. 03/010149. The compound can be obtained from commercial agents or can be obtained by producing by the method described in the publication.

In the composition for controlling plant diseases of the present invention, the weight ratio of ethaboxam to sedaxane is typically in the range of 1:0.01 to 1:50, preferably 1:0.05 to 1:20. When applied as a foliar spray, the weight ratio is typically in the range of 1:0.01 to 1:50, preferably 1:0.05 to 1:20. When used as a seed treatment agent, the weight ratio is typically in the range of 1:0.01 to 1:50, preferably 1:0.05 to 1:20.

The composition for controlling plant diseases of the present invention may be a simple mixture of ethaboxam and sedaxane. Alternatively, the composition for controlling plant diseases is typically produced by mixing ethaboxam and sedaxane with an inert carrier, and adding to the mixture a surfactant and other adjuvants as needed so that the mixture can be formulated into an oil agent, an emulsion, a flowable agent, a wettable powder, a granulated wettable powder, a powder agent, a granule agent and so on. The composition for controlling plant diseases mentioned above can be used as a seed treatment agent as it is or added with other inert ingredients.

In the composition for controlling plant diseases of the present invention, the total amount of ethaboxam and sedaxane is typically in the range of 0.1 to 99% by weight, preferably 0.2 to 90% by weight.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The composition for controlling plant diseases of the present invention is effective for the following plant diseases:

diseases of rice such as blast (Magnaporthe grisea), Helminthosporium leaf spot (Cochliobolus miyabeanus), sheath blight (Rhizoctonia solani), and bakanae disease (Gibberella fujikuroi);

diseases of wheat such as powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), and yellow spot (Pyrenophora tritici-repentis);

diseases of barley such as powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani);

diseases of corn such as smut (Ustilago maydis), brown spot (Cochliobolus heterostrophus), copper spot (Gloeocercospora sorghi), southern rust (Puccinia polysora), gray leaf spot (Cercospora zeae-maydis), and Rhizoctonia damping-off (Rhizoctonia solani);

diseases of citrus such as melanose (Diaporthe citri), scab (Elsinoe fawcetti), penicillium rot (Penicillium digitatum, P. italicum), and brown rot (Phytophthora parasitica, Phytophthora citrophthora);

diseases of apple such as blossom blight (Monilinia mali), canker (Valsa ceratosperma), powdery mildew (Podosphaera leucotricha), Alternaria leaf spot (Alternaria alternata apple pathotype), scab (Venturia inaequalis), bitter rot (Colletotrichum acutatum), crown rot (Phytophtora cactorum), blotch (Diplocarpon mali), ring rot (Botryosphaeria berengeriana), and violet root rot (Helicobasidium mompa);

diseases of pear such as scab (Venturia nashicola, V. pirina), black spot (Alternaria alternata Japanese pear pathotype), rust (Gymnosporangium haraeanum), and phytophthora fruit rot (Phytophtora cactorum);

diseases of peach such as brown rot (Monilinia fructicola), scab (Cladosporium carpophilum), and phomopsis rot (Phomopsis sp.);

diseases of grape such as anthracnose (Elsinoe ampelina), ripe rot (Glomerella cingulata), powdery mildew (Uncinula necator), rust (Phakopsora ampelopsidis), black rot (Guignardia bidwellii), and downy mildew (Plasmopara viticola);

diseases of Japanese persimmon such as anthracnose (Gloeosporium kaki), and leaf spot (Cercospora kaki, Mycosphaerella nawae);

diseases of gourd such as anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.);

diseases of tomato such as early blight (Alternaria solani), leaf mold (Cladosporium fulvum), and late blight (Phytophthora infestans);

diseases of eggplant such as brown spot (Phomopsis vexans), and powdery mildew (Erysiphe cichoracearum).

diseases of cruciferous vegetables: Alternaria leaf spot (Alternaria japonica), white spot (Cercosporella brassicae), clubroot (Plasmodiophora brassicae), and downy mildew (Peronospora parasitica);

diseases of welsh onion such as rust (Puccinia allii), and downy mildew (Peronospora destructor);

diseases of soybean such as purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), brown stem rot (Phytophthora sojae), and Rhizoctonia damping-off (Rhizoctonia solani);

diseases of kidney bean such as anthracnose (Colletotrichum lindemthianum);

diseases of peanut such as leaf spot (Cercospora personata), brown leaf spot (Cercospora arachidicola) and southern blight (Sclerotium rolfsii);

diseases of garden pea such as powdery mildew (Erysiphe pisi), and root rot (Fusarium solani f. sp. pisi);

diseases of potato such as early blight (Alternaria solani), late blight (Phytophthora infestans), pink rot (Phytophthora erythroseptica), powdery scab (Spongospora subterranean f. sp. subterranea), and black scurf (Rhizoctonia solani);

diseases of strawberry such as powdery mildew (Sphaerotheca humuli), and anthracnose (Glomerella cingulata);

diseases of tea such as net blister blight (Exobasidium reticulatum), white scab (Elsinoe leucospila), gray blight (Pestalotiopsis sp.), and anthracnose (Colletotrichum theaesinensis);

diseases of tobacco such as brown spot (Alternaria longipes), powdery mildew (Erysiphe cichoracearum), anthracnose (Colletotrichum tabacum), downy mildew (Peronospora tabacina), and black shank (Phytophthora nicotianae);

diseases of rapeseed such as sclerotinia rot (Sclerotinia sclerotiorum), and Rhizoctonia damping-off (Rhizoctonia solani);

diseases of cotton such as Rhizoctonia damping-off (Rhizoctonia solani);

diseases of sugar beet such as Cercospora leaf spot (Cercospora beticola), leaf blight (Rhizoctonia solani), Root rot (Rhizoctonia solani), and Aphanomyces root rot (Aphanomyces cochlioides);

diseases of rose such as black spot (Diplocarpon rosae), powdery mildew (Sphaerotheca pannosa), and downy mildew (Peronospora sparsa);

diseases of chrysanthemum and asteraceous plants such as downy mildew (Bremia lactucae), leaf blight (Septoria chrysanthemi-indici), and white rust (Puccinia horiana).

diseases of various groups such as diseases caused by Pythium spp. (Pythium debarianum, Pythium graminicola, Pythium irregulare, Pythium ultimum), gray mold (Botrytis cinerea), Sclerotinia rot (Sclerotinia sclerotiorum), or southern blight (Sclerotium rolfsii);

disease of Japanese radish such as Alternaria leaf spot (Alternaria brassicicola);

diseases of turfgrass such as dollar spot (Sclerotinia homeocarpa), and brown patch and large patch (Rhizoctonia solani);

disease of banana such as sigatoka (Mycosphaerella fijiensis, Mycosphaerella musicola);

disease of sunflower such as downy mildew (Plasmopara halstedii);

seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. or Diplodia spp.; and

viral diseases of various plants mediated by Polymixa spp. or Olpidium spp.; and so on.

In the case of treatment of seed, bulb or the like, examples of plant diseases for which high control efficacy of the present invention is expected include:

damping-off and root rot of wheat, barley, corn, rice, sorghum, soybean, cotton, rapeseed, sugar beet and turfgrass caused by Pythium spp. (Pythium debarianum, Pythium graminicola, Pythium irregulare, Pythium ultimum);

Rhizoctonia damping-off (Rhizoctonia solani) of wheat, barley, corn, rice, sorghum, soybean, cotton, rapeseed and sugar beet;

rust (Puccinia striiformis, P. graminis, P. recondita), loose smut (Ustilago tritici) and bunt (Tilletia caries) of wheat;

rust (Puccinia striiformis, P. graminis, P. hordei) and loose smut (Ustilago nuda) of barley;

smut (Ustilago maydis) of corn;

Aphanomyces root rot (Aphanomyces cochlioides) of sugar beet;

brown patch and large patch (Rhizoctonia solani) of turfgrass;

rust (Phakopsora pachyrhizi) and brown stem rot (Phytophthora sojae) of soybean;

black shank (Phytophthora nicotianae) of tobacco;

downy mildew (Plasmopara halstedii) of sunflower; and

late blight (Phytophthora infestans) of potato.

Plant diseases can be controlled by applying effective amounts of ethaboxam and sedaxane to the plant pathogens or to such a place as plant and soil where the plant pathogens inhabit or may inhabit.

Plant diseases can be controlled by applying effective amounts of ethaboxam and sedaxane to a plant or soil for growing plant. Examples of a plant which is the object of the application include foliages of plant, seeds of plant, bulbs of plant. As used herein, the bulb means a bulb, corm, rhizoma, stem tuber, root tuber and rhizophore.

When the application is conducted to plant pathogens, a plant or the soil for growing plant, ethaboxam and sedaxane may be separately applied for the same period, but they are typically applied as a composition for controlling plant diseases of the present invention for simplicity of the application.

Examples of the controlling method of the present invention include treatment of foliage of plants, such as foliage application; treatment of cultivation lands of plants, such as soil treatment; treatment of seeds, such as seed sterilization and seed coating; and treatment of bulbs such as seed tuber.

Examples of the treatment of foliage of plants in the controlling method of the present invention include treatment methods of applying to surfaces of plants, such as foliage spraying and trunk spraying. Examples of the treatment method of directly absorbing to plants before transplantation include a method of soaking entire plants or roots. A formulation obtained by using a solid carrier such as a mineral powder may be adhered to the roots.

Examples of the soil treatment method in the controlling method of the present invention include spraying onto the soil, soil incorporation, and perfusion of a chemical liquid into the soil (irrigation of chemical liquid, soil injection, and dripping of chemical liquid). Examples of the place to be treated include planting hole, furrow, around a planting hole, around a furrow, entire surface of cultivation lands, the parts between the soil and the plant, area between roots, area beneath the trunk, main furrow, growing soil, seedling raising box, seedling raising tray and seedbed. Examples of the treating period include before seeding, at the time of seeding, immediately after seeding, raising period, before settled planting, at the time of settled planting, and growing period after settled planting. In the above soil treatment, active ingredients may be simultaneously applied to the plant, or a solid fertilizer such as a paste fertilizer containing active ingredients may be applied to the soil. Also active ingredients may be mixed in an irrigation liquid, and, examples thereof include injecting to irrigation facilities such as irrigation tube, irrigation pipe and sprinkler, mixing into the flooding liquid between furrows and mixing into a water culture medium. Alternatively, an irrigation liquid is mixed with active ingredients in advance and, for example, used for treatment by an appropriate irrigating method including the irrigating method mentioned above and the other methods such as sprinkling and flooding.

Examples of the method of treating seeds or bulbs in the controlling method of the present invention include a method for treating seeds or bulbs to be protected from plant diseases with the composition for controlling plant diseases of the present invention and specific examples thereof include a spraying treatment in which a suspension of the composition for controlling plant diseases of the present invention is atomized and sprayed on the seed surface or the bulb surface; a smearing treatment in which a wettable powder, an emulsion or a flowable agent of the composition for controlling plant diseases of the present invention is applied to seeds or bulbs with a small amount of water added or without dilution; an immersing treatment in which seeds are immersed in a solution of the composition for controlling plant diseases of the present invention for a certain period of time; film coating treatment; and pellet coating treatment.

When foliage of a plant or soil is treated with ethaboxam and sedaxane, the amounts of ethaboxam and sedaxane used for the treatment may be changed depending on the kind of the plant to be treated, the kind and the occurring frequency of the diseases to be controlled, formulation form, treatment period, climatic condition and so on, but the total amount of ethaboxam and sedaxane (hereinafter, referred to as the amount of the active ingredients) per 10,000m² is typically 1 to 5,000 g and preferably 2 to 400 g.

The emulsion, wettable powder and flowable agent are typically diluted with water, and then sprinkled for the treatment. In these case, the total concentration of the ethaboxam and sedaxane is typically in the range of 0.0001 to 3% by weight and preferably 0.0005 to 1% by weight. The powder agent and granule agent are typically used for the treatment without being diluted.

In the treatment of seeds, the amount of the active ingredients to be applied is typically in the range of 0.001 to 10 g, preferably 0.01 to 3 g per 1 kg of seeds.

The control method of the present invention can be used in agricultural lands such as fields, paddy fields, lawns and orchards or in non-agricultural lands.

The present invention can be used to control diseases in agricultural lands for cultivating the following “plant” and the like without adversely affecting the plant and so on.

Examples of the plants are as follows:

crops such as corn, rice, wheat, barley, rye, oat, sorghum, cotton, soybean, peanut, buckwheat, beet, rapeseed, sunflower, sugar cane, and tobacco;

vegetables such as solanaceous vegetables including eggplant, tomato, pimento, pepper and potato, cucurbitaceous vegetables including cucumber, pumpkin, zucchini, water melon, melon and squash, cruciferous vegetables including Japanese radish, white turnip, horseradish, kohlrabi, Chinese cabbage, cabbage, leaf mustard, broccoli and cauliflower, asteraceous vegetables including burdock, crown daisy, artichoke and lettuce, liliaceous vegetables including green onion, onion, garlic and asparagus, ammiaceous vegetables including carrot, parsley, celery and parsnip, chenopodiaceous vegetables including spinach and Swiss chard, lamiaceous vegetables including Perilla frutescens, mint and basil, strawberry, sweet potato, Dioscorea japonica, and colocasia;

flowers;

foliage plants;

turf grasses;

fruits such as pomaceous fruits including apple, pear, Japanese pear, Chinese quince and quince, stone fleshy fruits including peach, plum, nectarine, Prunus mume, cherry fruit, apricot and prune, citrus fruits including Citrus unshiu, orange, lemon, rime and grapefruit, nuts including chestnuts, walnuts, hazelnuts, almond, pistachio, cashew nuts and macadamia nuts, berries including blueberry, cranberry, blackberry and raspberry, grape, kaki fruit, olive, Japanese plum, banana, coffee, date palm, and coconuts; and

trees other than fruit trees such as tea, mulberry, flowering plant, and roadside trees including ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate.

Particularly, the control method of the present invention can be used to control diseases in agricultural lands for cultivating corn, rice, wheat, barley, sorghum, cotton, soybean, beet, rapeseed, turf grasses or potato.

The aforementioned “plants” include plants, to which resistance to HPPD inhibitors such as isoxaflutole, ALS inhibitors such as imazethapyr or thifensulfuron-methyl, EPSP synthetase inhibitors such as glyphosate, glutamine synthetase inhibitors such as the glufosinate, acetyl-CoA carboxylase inhibitors such as sethoxydim, and herbicides such as bromoxynil, dicamba, 2,4-D, etc. has been conferred by a classical breeding method or genetic engineering technique.

Examples of a “plant” on which resistance has been conferred by a classical breeding method include rape, wheat, sunflower and rice resistant to imidazolinone ALS inhibitory herbicides such as imazethapyr, which are already commercially available under a product name of Clearfield (registered trademark). Similarly, there is soybean on which resistance to sulfonylurea ALS inhibitory herbicides such as thifensulfuron-methyl has been conferred by a classical breeding method, which is already commercially available under a product name of STS soybean. Similarly, examples on which resistance to acetyl-CoA carboxylase inhibitors such as trione oxime or aryloxy phenoxypropionic acid herbicides has been conferred by a classical breeding method include SR corn. The plant on which resistance to acetyl-CoA carboxylase inhibitors has been conferred is described in Proceedings of the National Academy of Sciences of the United States of America (Proc. Natl. Acad. Sci. USA), vol. 87, pp. 7175-7179 (1990). A variation of acetyl-CoA carboxylase resistant to an acetyl-CoA carboxylase inhibitor is reported in Weed Science, vol. 53, pp. 728-746 (2005) and a plant resistant to acetyl-CoA carboxylase inhibitors can be generated by introducing a gene of such an acetyl-CoA carboxylase variation into a plant by genetically engineering technology, or by introducing a variation conferring resistance into a plant acetyl-CoA carboxylase. Furthermore, plants resistant to acetyl-CoA carboxylase inhibitors or ALS inhibitors or the like can be generated by introducing a site-directed amino acid substitution variation into an acetyl-CoA carboxylase gene or the ALS gene of the plant by introduction a nucleic acid into which has been introduced a base substitution variation represented Chimeraplasty Technique (Gura T. 1999. Repairing the Genome's Spelling Mistakes. Science 285: 316-318) into a plant cell.

Examples of a plant on which resistance has been conferred by genetic engineering technology include corn, soybean, cotton, rape, sugar beet resistant to glyphosate, which is already commercially available under a product name of RoundupReady (registered trademark), AgrisureGT, etc. Similarly, there are corn, soybean, cotton and rape which are made resistant to glufosinate by genetic engineering technology, a kind, which is already commercially available under a product name of LibertyLink (registered trademark). A cotton made resistant to bromoxynil by genetic engineering technology is already commercially available under a product name of BXN likewise.

The aforementioned “plants” include genetically engineered crops produced using such genetic engineering techniques, which, for example, are able to synthesize selective toxins as known in genus Bacillus.

Examples of toxins expressed in such genetically engineered crops include: insecticidal proteins derived from Bacillus cereus or Bacillus popilliae; δ-endotoxins such as Cry1Ab, Cry1Ac, Cry1F, Cry1Fa2, Cry2Ab, Cry3A, Cry3Bb1 or Cry9C, derived from Bacillus thuringiensis; insecticidal proteins such as VIP1, VIP2, VIP3, or VIP3A; insecticidal proteins derived from nematodes; toxins generated by animals, such as scorpion toxin, spider toxin, bee toxin, or insect-specific neurotoxins; mold fungi toxins; plant lectin; agglutinin; protease inhibitors such as a trypsin inhibitor, a serine protease inhibitor, patatin, cystatin, or a papain inhibitor; ribosome-inactivating proteins (RIP) such as lycine, corn-RIP, abrin, luffin, saporin, or briodin; steroid-metabolizing enzymes such as 3-hydroxysteroid oxidase, ecdysteroid-UDP-glucosyl transferase, or cholesterol oxidase; an ecdysone inhibitor; HMG-COA reductase; ion channel inhibitors such as a sodium channel inhibitor or calcium channel inhibitor; juvenile hormone esterase; a diuretic hormone receptor; stilbene synthase; bibenzyl synthase; chitinase; and glucanase.

Toxins expressed in such genetically engineered crops also include: hybrid toxins of δ-endotoxin proteins such as Cry1Ab, Cry1Ac, Cry1F, Cry1Fa2, Cry2Ab, Cry3A, Cry3Bb1, Cry9C, Cry34Ab or Cry35Ab and insecticidal proteins such as VIP1, VIP2, VIP3 or VIP3A; partially deleted toxins; and modified toxins. Such hybrid toxins are produced from a new combination of the different domains of such proteins, using a genetic engineering technique. As a partially deleted toxin, Cry1Ab comprising a deletion of a portion of an amino acid sequence has been known. A modified toxin is produced by substitution of one or multiple amino acids of natural toxins.

Examples of such toxins and genetically engineered plants capable of synthesizing such toxins are described in EP-A-0 374 753, WO 93/07278, WO 95/34656, EP-A-0 427 529, EP-A-451 878, WO 03/052073, etc.

Toxins contained in such genetically engineered plants are able to confer resistance particularly to insect pests belonging to Coleoptera, Hemiptera, Diptera, Lepidoptera and Nematodes, to the plants.

Genetically engineered plants, which comprise one or multiple insecticidal pest-resistant genes and which express one or multiple toxins, have already been known, and some of such genetically engineered plants have already been on the market. Examples of such genetically engineered plants include YieldGard (registered trademark) (a corn variety for expressing Cry1Ab toxin), YieldGard Rootworm (registered trademark) (a corn variety for expressing Cry3Bb1 toxin), YieldGard Plus (registered trademark) (a corn variety for expressing Cry1Ab and Cry3Bb1 toxins), Herculex I (registered trademark) (a corn variety for expressing phosphinotricine N-acetyl transferase (PAT) so as to confer resistance to Cry1Fa2 toxin and glufosinate), NuCOTN33B (registered trademark) (a cotton variety for expressing Cry1Ac toxin), Bollgard I (registered trademark) (a cotton variety for expressing Cry1Ac toxin), Bollgard II (registered trademark) (a cotton variety for expressing Cry1Ac and Cry2Ab toxins), VIPCOT (registered trademark) (a cotton variety for expressing VIP toxin), NewLeaf (registered trademark) (a potato variety for expressing Cry3A toxin), NatureGard (registered trademark) Agrisure (registered trademark) GT Advantage (GA21 glyphosate-resistant trait), Agrisure (registered trademark) CB Advantage (Bt11 corn borer (CB) trait), and Protecta (registered trademark).

The aforementioned “plants” also include crops produced using a genetic engineering technique, which have ability to generate antipathogenic substances having selective action.

A PR protein and the like have been known as such antipathogenic substances (PRPs, EP-A-0 392 225). Such antipathogenic substances and genetically engineered crops that generate them are described in EP-A-0 392 225, WO 95/33818, EP-A-0 353 191, etc.

Examples of such antipathogenic substances expressed in genetically engineered crops include: ion channel inhibitors such as a sodium channel inhibitor or a calcium channel inhibitor (KP1, KP4 and KP6 toxins, etc., which are produced by viruses, have been known); stilbene synthase; bibenzyl synthase; chitinase; glucanase; a PR protein; and antipathogenic substances generated by microorganisms, such as a peptide antibiotic, an antibiotic having a hetero ring, a protein factor associated with resistance to plant diseases (which is called a plant disease-resistant gene and is described in WO 03/000906). These antipathogenic substances and genetically engineered plants producing such substances are described in EP-A-0392225, W095/33818, EP-A-0353191, etc.

The “plant” mentioned above includes plants on which advantageous characters such as characters improved in oil stuff ingredients or characters having reinforced amino acid content have been conferred by genetically engineering technology. Examples thereof include VISTIVE (registered trademark) low linolenic soybean having reduced linolenic content) or high-lysine (high-oil) corn (corn with increased lysine or oil content). The “plant” mentioned above also includes plants on which tolerance to environmental stress such as drought stress, salt stress, heat stress, cold stress, pH stress, light stress, or stress caused by soil pollution with heavy metals has been conferred by genetic engineering technology.

Stack varieties are also included in which are combined a plurality of advantageous characters such as the classic herbicide characters mentioned above or herbicide tolerance genes, harmful insect resistance genes, antipathogenic substance producing genes, characters improved in oil stuff ingredients or characters having reinforced amino acid content, and environmental stress tolerance genes.

### EXAMPLES

While the present invention will be more specifically described by way of formulation examples, seed treatment examples, and test examples in the following, the present invention is not limited to the following examples. In the following examples, the part represents part by weight unless otherwise noted in particular.

### Formulation Example 1

Fully mixed are 2.5 parts of ethaboxam, 1.5 parts of sedaxane, 14 parts of polyoxyethylene styrylphenyl ether, 6 parts of calcium dodecyl benzene sulfonate and 76 parts of xylene, so as to obtain an emulsion.

### Formulation Example 2

Five (5) parts of ethaboxam, 5 parts of sedaxane, 35 parts of a mixture of white carbon and a polyoxyethylene alkyl ether sulfate ammonium salt (weight ratio 1:1) and 55 parts of water are mixed, and the mixture is subjected to fine grinding according to a wet grinding method, so as to obtain a flowable formulation.

### Formulation Example 3

Ten (10) parts of ethaboxam, 5 parts of sedaxane, 1.5 parts of sorbitan trioleate and 28.5 parts of an aqueous solution containing 2 parts of polyvinyl alcohol are mixed, and the mixture is subjected to fine grinding according to a wet grinding method. Thereafter, 45 parts of an aqueous solution containing 0.05 part of Xanthan gum and 0.1 part of aluminum magnesium silicate is added to the resultant mixture, and 10 parts of propylene glycol is further added thereto. The obtained mixture is blended by stirring, so as to obtain a flowable formulation.

### Formulation Example 4

Fifteen (15) parts of ethaboxam, 25 parts of sedaxane, 5 parts of propylene glycol (manufactured by Nacalai Tesque), 5 parts of SoprophorFLK (manufactured by Rhodia Nikka), 0.2 parts of an anti-form C emulsion (manufactured by Dow Corning), 0.3 parts of proxel GXL (manufactured by Arch Chemicals) and 49.5 parts of ion-exchange water are mixed so as to obtain a bulk slurry. 150 parts of glass beads (diameter=1 mm) are put into 100 parts of the slurry, and the slurry is ground for 2 hours while being cooled with a cooling water. After ground, the resultant is filtered to remove the glass beads and a flowable formulation is obtained.

### Formulation Example 5

Thirty (30) parts of ethaboxam, 20 parts of sedaxane, 38.5 parts of NN kaolin clay (manufactured by Takehara Chemical Industrial), 10 parts of MorwetD425 and 1.5 parts of MorwerEFW (manufactured by Akzo Nobel Corp.) are mixed to obtain an AI premix. This premix is ground with a jet mill so as to obtain a powder formulation.

### Formulation Example 6

One (1) part of ethaboxam, 4 parts of sedaxane, 1 part of synthetic hydrated silicon oxide, 2 parts of calcium lignin sulfonate, 30 parts of bentonite and 62 parts of kaolin clay are fully ground and mixed, and the resultant mixture is added with water and fully kneaded, and then subjected to granulation and drying so as to obtain a granule formulation.

### Formulation Example 7

One (1) part of ethaboxam, 2 parts of sedaxane, 87 parts of kaolin clay and 10 parts of talc are fully ground and mixed so as to obtain a powder formulation.

### Formulation Example 8

Fifteen (15) parts of ethaboxam, 20 parts of sedaxane, 3 parts of calcium lignin sulfonate, 2 parts of sodium lauryl sulfate and 60 parts of synthetic hydrated silicon oxide are fully ground and mixed so as to obtain wettable powders.

### Seed Treatment Example 1

An emulsion prepared as in Formulation example 1 is used for smear treatment in an amount of 500 ml per 100 kg of dried sorghum seeds using a rotary seed treatment machine (seed dresser, produced by Hans-Ulrich Hege GmbH) so as to obtain treated seeds.

### Seed Treatment Example 2

A flowable formulation prepared as in Formulation example 2 is used for smear treatment in an amount of 50 ml per 10 kg of dried rape seeds using a rotary seed treatment machine (seed dresser, produced by Hans-Ulrich Hege GmbH) so as to obtain treated seeds.

### Seed Treatment Example 3

A flowable formulation prepared as in Formulation example 3 is used for smear treatment in an amount of 40 ml per 10 kg of dried corn seeds using a rotary seed treatment machine (seed dresser, produced by Hans-Ulrich Hege GmbH) so as to obtain treated seeds.

### Seed Treatment Example 4

Five (5) parts of a flowable formulation prepared as in Formulation example 4, 5 parts of pigment BPD6135 (manufactured by Sun Chemical) and 35 parts of water are mixed to prepare a mixture. The mixture is used for smear treatment in an amount of 60 ml per 10 kg of dried rice seeds using a rotary seed treatment machine (seed dresser, produced by Hans-Ulrich Hege GmbH) so as to obtain treated seeds.

### Seed Treatment Example 5

A powder agent prepared as in Formulation example 5 is used for powder coating treatment in an amount of 50 g per 10 kg of dried corn seeds so as to obtain treated seeds.

### Seed Treatment Example 6

An emulsion prepared as in Formulation example 1 is used for smear treatment in an amount of 500 ml per 100 kg of dried sugar beet seeds using a rotary seed treatment machine (seed dresser, produced by Hans-Ulrich Hege GmbH) so as to obtain treated seeds.

### Seed Treatment Example 7

A flowable formulation prepared as in Formulation example 2 is used for smear treatment in an amount of 50 ml per 10 kg of dried soybean seeds using a rotary seed treatment machine (seed dresser, produced by Hans-Ulrich Hege GmbH) so as to obtain treated seeds.

### Seed Treatment Example 8

A flowable formulation prepared as in Formulation example 3 is used for smear treatment in an amount of 50 ml per 10 kg of dried wheat seeds using a rotary seed treatment machine (seed dresser, produced by Hans-Ulrich Hege GmbH) so as to obtain treated seeds.

### Seed Treatment Example 9

Five (5) parts of a flowable formulation prepared as in Formulation example 4, 5 parts of pigment BPD6135 (manufactured by Sun Chemical) and 35 parts of water are mixed and the resultant mixture is used for smear treatment in an amount of 70 ml per 10 kg of potato tuber pieces using a rotary seed treatment machine (seed dresser, produced by Hans-Ulrich Hege GmbH) so as to obtain treated seeds.

### Seed Treatment Example 10

Five (5) parts of a flowable formulation prepared as in Formulation example 4, 5 parts of pigment BPD6135 (manufactured by Sun Chemical) and 35 parts of water are mixed and the resultant mixture is used for smear treatment in an amount of 70 ml per 10 kg of sunflower seeds using a rotary seed treatment machine (seed dresser, produced by Hans-Ulrich Hege GmbH) so as to obtain treated seeds.

### Seed Treatment Example 11

A powder prepared as in Formulation example 5 is used for powder coating treatment in an amount of 40 g per 10 kg of dried cotton seeds so as to obtain treated seeds.

### Test Example 1

A dimethylsulfoxide (hereinafter, abbreviated to as DMSO) solution of ethaboxam and a DMSO solution of sedaxane were respectively prepared, and these solutions were mixed to prepare a DMSO mixed solution containing 1% by weight of ethaboxam and 1% by weight of sedaxane. Five (5) g of corn (Pioneer) seeds and 12.5 μL of the DMSO mixed solution were mixed by shaking in a 50-ml conical tube and then allowed to stand overnight to prepare treated seeds. A plastic pot was filled with sandy soil and the treated seeds were sown on it and then covered with sandy soil which had been mixed with a bran culture of Pythium damping-off pathogen (Pythium irregulare). The sown seeds were watered and then cultured at 15° C. under humidity for 2 weeks. The number of emerging corn seedlings was checked and the incidence of disease was calculated by Equation 1.

In order to calculate a control value, the incidence of disease was also checked in the case in which the seeds had not been treated with the test compounds.

The control value was calculated by the Equation 2 based on the incidence of disease thus determined.

The results are shown in Table 1.

Incidence of disease={(Total number of sowed seeds)−(Number of emerging seedlings}×100/(Total number of sowed seeds) “Equation 1”

Control value=100×(A×B)/A “Equation 2”
A: Incidence of disease of plants treated with none of the test compounds
B: Incidence of disease of plants treated with the test compounds

TABLE 1

| | Active ingredient | Control |
|---|---|---|
| Test compounds | dosage (g/100 kg seeds) | value |
| Ethaboxam + sedaxane | 2.5 + 2.5 | 71 |

### Test Example 2

A DMSO solution of ethaboxam and a DMSO solution of sedaxane were respectively prepared, and these solutions were mixed to prepare a DMSO mixed solution containing 2% by weight of ethaboxam and 1% by weight of sedaxane. Ten (10) μL of the DMSO mixed solution and 1 g of cucumber (Sagamihanjiro) seeds were mixed by shaking in a 15-ml conical tube and then allowed to stand overnight to prepare treated seeds. A plastic pot was filled with sandy soil and the treated seeds were sown on it and then covered with sandy soil which had been mixed with a bran culture of Pythium damping-off pathogen (Pythium irregulare). The sown seeds were watered and then cultured at 18° C. under humidity for 1 week. The number of emerging cucumber seedlings was checked and the incidence of disease was calculated by Equation 1.

In order to calculate a control value, the incidence of disease was also checked in the case in which the seeds had not been treated with the test compounds.

The control value was calculated by the Equation 2 based on the incidence of disease thus determined.

The results are shown in Table 2.

TABLE 2

| | Active ingredient | Control |
|---|---|---|
| Test compounds | dosage (g/100 kg seeds) | value |
| Ethaboxam + sedaxane | 10 + 5 | 88 |

### Test Example 3

A DMSO solution of ethaboxam and a DMSO solution of sedaxane are respectively prepared, and these solutions are mixed to prepare a DMSO mixed solution containing 2% by weight of ethaboxam and 1% by weight of sedaxane and a DMSO mixed solution containing 1% by weight of ethaboxam and 1% by weight of sedaxane. Twenty-five (25) μL of the respective DMSO mixed solution and 10 g of corn (Pioneer) seeds are mixed by shaking in a 50-ml conical tube and then allowed to stand overnight to prepare treated seeds. A plastic pot is filled with sandy soil and the treated seeds are sown on it and then covered with sandy soil which has been mixed with a bran culture of Pythium damping-off pathogen (Pythium ultimum). The sown seeds are watered and then cultured at 18° C. under humidity for 2 weeks, and control efficacy is checked. As a result, excellent efficacy for controlling the plant disease is observed in the respective seeds treated with ethaboxam and sedaxane.

### INDUSTRIAL APPLICABILITY

This invention is capable of providing a composition for controlling plant diseases having excellent activity and a method for effectively controlling plant diseases.

1. A composition for controlling plant diseases comprising, as active ingredients, ethaboxam and sedaxane.

2. The composition according to claim 1, wherein a weight ratio of ethaboxam to sedaxane is in the range of 1:0.01 to 1:50.

3. A seed treatment agent comprising, as active ingredients, ethaboxam and sedaxane.

4. A plant seed treated with effective amounts of ethaboxam and sedaxane.

5. A method for controlling plant diseases which comprises applying effective amounts of ethaboxam and sedaxane to a plant or soil for growing plant.

6. Combined use for controlling plant diseases of ethaboxam and sedaxane.
